(19) United States
(12) Patent Application Publication
(10) Pub. No.: US 2006/0104869 A1
(43) Pub. Date: May 18, 2006

(54) Apparatus for carrying out chemical process using set of solvents undergoing reversible change between mutual dissolution and separation depending on temperature

(75) Inventors: Kazuhiro Chiba, Tokyo (JP); Tomohiro Marui, Tokyo (JP)

Correspondence Address: Robert H Hammer III, Suite I, 3121 Springbank Lane, Charlotte, NC, 28226, US

(73) Assignee: Tokyo University of Agriculture and Technology TLO Co., Ltd., Tokyo (JP)

(21) Appl. No.: 10/525,467

(22) PCT Filed: Aug. 29, 2003
(86) PCT No.: PCT/JP03/11054

§ 371 Date: Aug. 22, 2005

(30) Foreign Application Priority Data
Aug. 29, 2002 (JP) 2002-251051

(51) Int. Cl. B01J 19/00

(52) U.S. Cl. 422/129

(57) ABSTRACT

(Problems) A reaction container (apparatus) with a high efficiency, which can overcome problems of common chemically processing apparatuses using a solvent set where the compatible state and the separated state are reversibly changeable depending on a temperature, i.e. problems of the apparatus disclosed in Japanese Patent Application 2002-198242, namely the separation over time and spatial separation between compatible state and separated state. (Means for Solving the Problems) A temperature distribution is formed inside a reaction container, such that the temperature of one (optional) partial region inside the reaction container is the temperature for making first and second solvent solutions at a compatible state or a higher temperature, while the temperature of the other partial region is the temperature for making the solutions at a separated state or a lower temperature. Additionally, a reaction-promoting energy such as light and electricity is fed to the part at the compatible state.

### DISCLOSURE OF THE INVENTION

The present invention relates to a chemically processing apparatus using the “compatible-multiphase organic solvent system” of Japanese Patent Application 2001-254109. Concerning apparatuses for processes of peptide synthesis, in particular, the invention provides an improved technique of the apparatus disclosed in Japanese Patent Application 2002-198242 as well as an apparatus appropriately realizing a peptide synthesis process using the reagents and carriers for peptide synthesis as disclosed in Japanese Patent Application 2002-220569 and 2002-226946. Herein, this invention is not limited to such peptide synthesis processes. In other words, the invention provides common chemically processing apparatuses using a combination of solvents where the state of a homogenously compatible mixture solution (referred to as “compatible state” hereinbelow) and the state of separated solvents (referred to as “separated state” hereinbelow) are reversibly changeable in a manner dependent on the temperature. The combination of such solvents is described as “solvent set” hereinbelow.

The inventor proposed a novel solvent set capable of readily controlling the change in state between compatible state and separated state in a manner dependent on the temperature to constitute a chemical process enabling ready control of the reaction and ready separation and purification of the resulting product via the control of the change in state. As one example, electrical properties can be controlled by the change between compatible state and separated state. Accordingly, an electrochemical process can be established using the properties, while a liquid-phase peptide synthesis in no way inferior to the solid-phase peptide synthesis in the related art can be established. The latter is disclosed in “A liquid-phase peptide synthesis in cyclohexane-based biphasic thermomorphic systems”, Kazuhiro Chiba, Yusuke Kono, Shokaku Kim, Kohsuke Nishimoto, Yoshikazu Kitano and Masahiro Tada, Chem. Comun., 2002, (Advanced Article), The Royal Society of Chemistry, 1766-1767, 2002, (First published on the web 15^{th} Jul. 2002). Herein, the solvent set means a combination of a first solvent which may or may not be a mixture solvent of plural solvents and a second solvent which may or may not be a mixture solvent of plural solvents. The solvent set is the same one represented as the “compatible-multiphase organic solvent system” described in Japanese Patent Application 2001-254109. The solvent set is now described below.

<Solvent Set Where the Compatible State and the Separated State are Reversibly Changeable in a Manner Dependent on the Temperature>

Japanese Patent Application 2001-254109 entitled as “Compatible-multiphase organic solvent system” discloses a solvent set where the compatible state and the separated state are reversibly changeable in a manner dependent on the temperature. Herein, the first solvent and the second solvent individually may or may not be a mixture solvent of plural solvents. Additionally, Japanese Patent Application 2002-198242 discloses a peptide synthesis apparatus using the solvent set in particular.

Japanese Patent Application 2002-198242 discloses an example of an experiment of mixing together a first solvent and a second solvent, where a dye is mixed with the second solvent in the lower layer to make the resulting mixture visible. In this example, the mixture is at a phase-separated state at 25° C.; when heated at 45° C., the mixture is at a compatible state; and when cooled, the mixture is again back to the separated state. It is demonstrated that the solvent set reversibly changes between the compatible state and the phase-separated state in a manner dependent on the temperature.

Fundamentally, the first solvent is an organic solvent of low polarity. The compound group composing the solvent includes alkane, cycloalkane, alkene, alkyne and aromatic compounds. Among them, preferably, the first solvent is a cycloalkane compound. “Cyclohexane” is particularly preferable. It is possibly suggested that the change of cyclohexane between the chair-form isomer and the boat-form isomer occurs under relatively mild conditions in terms of temperature because of a relation with the other solvent. Advantageously, cyclohexane has such a relatively high melting point of 6.5° C. that a reaction product after the reaction can be solidified and separated. For the recovery step as the final step, cyclohexane is advantageous. Thus, cyclohexane is preferable in such terms.

Meanwhile, the organic solvent composing the other solvent or a mixture solvent (second solvent) to be used in combination with the first solvent is fundamentally an organic solvent of high polarity. The organic solvent is preferably at least one selected from the group consisting of nitroalkane, nitrile, alcohol, halogenated alkyl, amide compounds and sulfoxide.

More specifically, the second solvent is nitroalkane with an alkyl group with one, 2 or 3 carbon atoms, nitrile with an alkyl group with one, 2 or 3 carbon atoms, N-dialkyl- or N-monoalkylamide with an alkyl group, acyl group or formyl group with a total of 6 or less carbon atoms as an amide compound, alcohol with 8 or less carbon atoms, sulfoxide with an alkyl group with one, 2 or 3 carbon atoms, or halogenated alkyl with an alkyl group with 6 or less carbon atoms.

<Compatible Temperature>

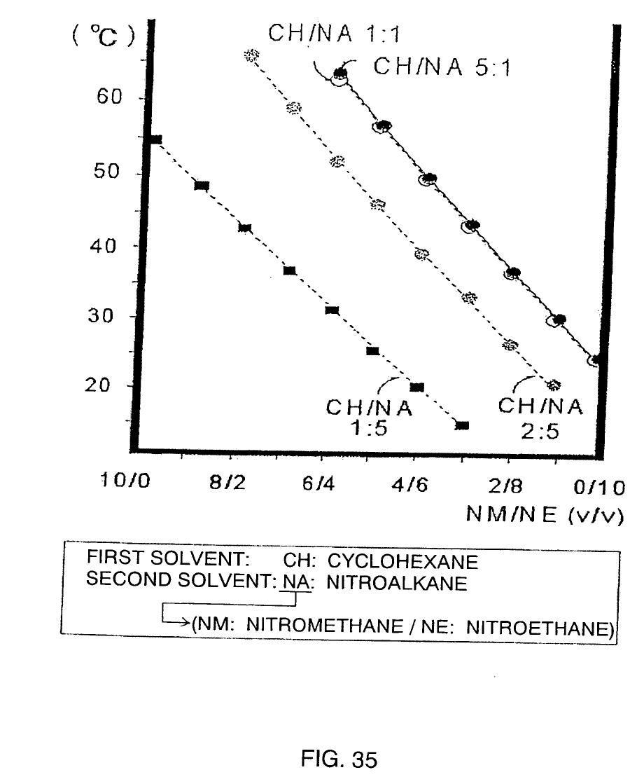

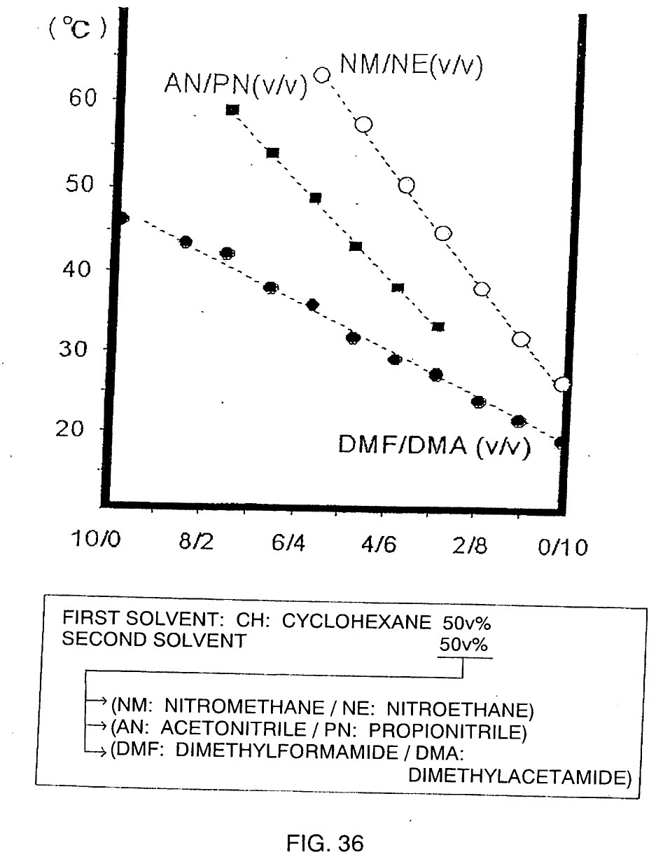

By modifying the composition of the first solvent or the second solvent, the temperature at which the state changes between the compatible state and the phase-separated state is freely modifiable. For example, Japanese Patent Application 2002-198242 discloses a chart depicting the change of the compatible temperature vs. the composition of cyclohexane (CH) as a first solvent and the composition of a nitroalkane mixture solvent (NA) as a second solvent, where the volume ratio of CH and NA is set at 1:5, 2:5, 1:1 and 5:1 as a parameter and the compatible temperature data are plotted in case of mixing together nitromethane (NM) and nitroethane (NE) composing each NA, on the horizontal axis showing the volume mix ratio of the two solvents (NM and NE) and on the vertical axis showing the solvent temperature (FIG. 35). Additionally, the Application discloses such chart where cyclohexane (CH) as the first solvent and a second solvent are fixed at an equal volume of 1:1 (50% by volume, individually); the second solvent is a mixture solvent of nitromethane (NM) and nitroethane (NE), a mixture solvent of acetonitrile (AN) and propionitrile (PN) or a mixture solvent of dimethylformamide (DMF) and dimethylacetamide (DMA); the compatible temperature data are plotted in case of mixing together the two solvents on the horizontal axis showing the volume mix ratio of the solvents constituting the second solvent and on the vertical axis showing the solvent temperature (FIG. 36).

The charts disclosed therein indicate that the compatible temperature at a temperature between 20° C. and 60° C. changes in a manner dependent on the first and second solvent compositions. In a solvent set of a first solvent and a second solvent, specifically, the compatible temperatures of the two solvents can be modified, with a measure capable of modifying the first and second solvent compositions. In other words, the chemical reaction at the compatible state can be progressed at a level of low temperature.

The first and second solvent compositions may be constituted with a mix ratio of the first solvent and the second solvent or may be constituted with a mix ratio of elements composing a mixture solvent composing the first solvent or the second solvent, as a mixture solvent. The measure for modifying the composition satisfactorily may increase or decrease or adjust the supply of the first solvent or the second solvent or may add a new element to a mixture solvent so as to modify the composition, in feeding the first solvent and the second solvent in mixture.

<Chemical Process Using Solvent Set>

The chemical process using the solvent set is not limited to a specific process. Examples thereof include the Diels-Alder reaction process with its example disclosed in Japanese Patent Application 2001-254109, and a reaction process of peptide synthesis, which is entitled as “Liquid-phase peptide synthesis process including sequentially adding amino acids with compatible-multiphase organic solvent system” as disclosed in Japanese Patent Application 2001-385493. Additionally, Japanese Patent Application 2002-226946 discloses an electrochemically cleavable carrier as a carrier preferable for peptide synthesis.

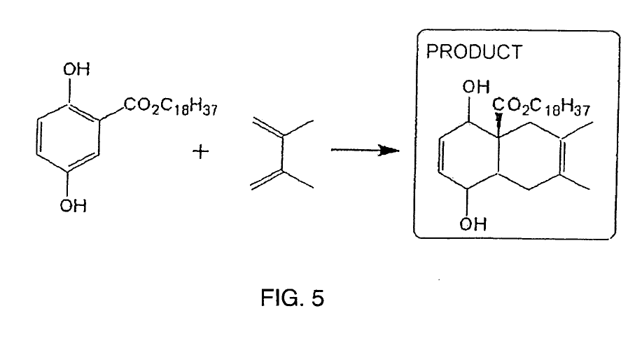

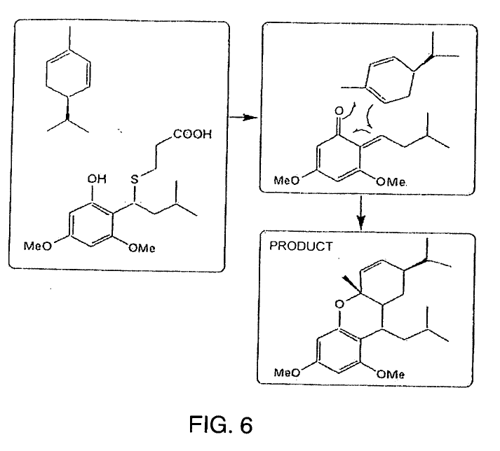

For example, photoenergy and electrical energy are sometimes given so as to promote a chemical reaction in the Diels-Alder reaction process. The preceding Patent Applications exemplify such reaction. Additionally, electrical energy is given so as to induce only a specific reaction of cleavage in a reaction process of peptide synthesis using an electrochemically cleavable carrier (oxidation reaction by electrolysis). See FIGS. 5 and 6 about these reaction examples.

<Chemically Processing Apparatus>

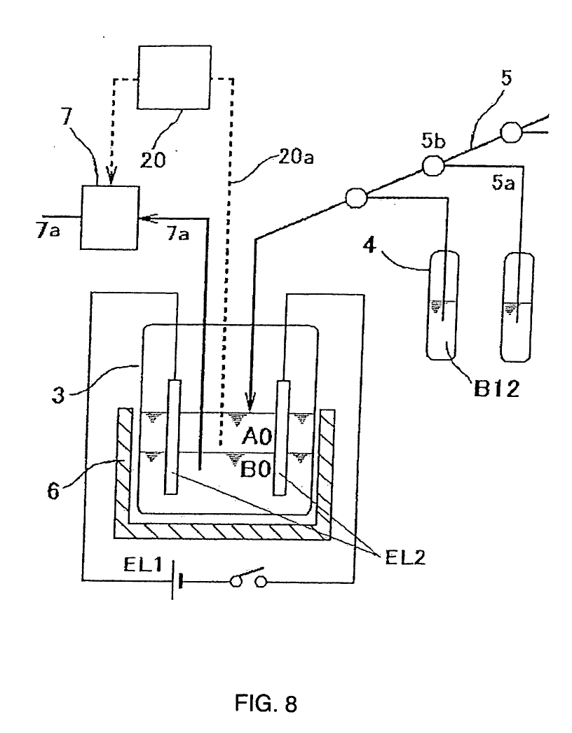

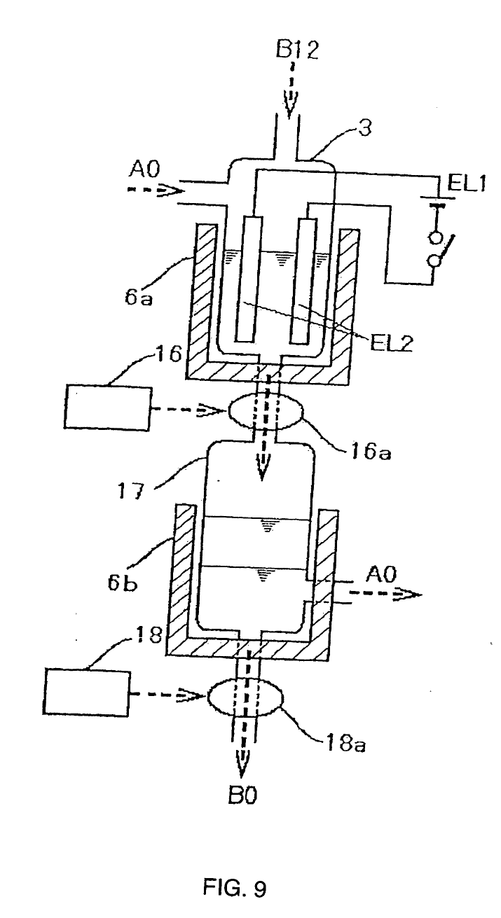

Typical examples of a chemically processing apparatus using such solvent set are shown in FIGS. 8 and 9, which are disclosed in Japanese Patent Application 2002-198242. Electric source EL1, electrode EL2 for electrochemical reaction and so on, in these figures are not described in the figures disclosed in Japanese Patent Application 2002-198242. However, no significant difference in fundamental constitution is found. FIG. 8 depicts a chemical process using a solvent set with temperature control measure 6 of synthesis tank 3, in a manner dependent on the “change of the temperature of the synthesis tank over time”, which can adjust the temperature of a solution of the first and second solvents in the synthesis tank 3 to a temperature of a compatible state, or higher at a time during a certain process and to a temperature for a separated state at a time during the process, or lower. Meanwhile, FIG. 9 depicts a chemical process using a solvent set by arranging separation tank 17 where a solution of the first and second solvents is at a phase-separated state, in addition to synthesis tank 3, where the synthesis tank 3 and the separation tank 17 are individually temperature-controlled to a temperature of a compatible state, or higher and to a temperature of a separated state, or lower, respectively. In such manner, a chemical process using the solvent set is carried out by the “transfer of the places of solvents between synthesis tank and separation tank”. (FIGS. 8 and 9 are fundamentally the same as shown in Japanese Patent Application 2002-198242, where the symbols except 3 and 17 are described in the section “Description of Symbols” and are therefore not described.)

Additionally when a reaction process for peptide synthesis using an electrochemically cleavable carrier disclosed in Japanese Patent Application 2002-226946 is to be done with the peptide synthesis reaction apparatus of Japanese Patent Application 2002-198242, electric source L1 and electrode EL2 for electrochemical reaction in FIGS. 8 and 9 may be needed. Herein, a measure for retaining and transferring the electrode EL2 may be arranged to insert the electrode into the reaction container on a needed basis for electrochemical reaction and subsequently draw out the electrode after the reaction.

(Problems That the Invention is to Solve)

A first problem to be overcome by the invention is to overcome the processing time loss in the change of the chemical process using such solvent set over time with the “change of the temperature of synthesis tank over time” or to overcome the time loss involved in the transfer of the chemical process using such solvent set with the “transfer of the places of the solvents between the synthesis tank and the separation tank”, where these processes are carried out with the apparatus disclosed in Japanese Patent Application 2002-198242.

A second problem to be overcome by the invention is to overcome general problems of chemical reaction systems. For chemical reaction systems, specifically, a great number of methods for producing products are used, including once generating a reaction intermediate from a certain starting material and then immediately capturing the reaction intermediate with a capturing agent of the intermediate, which preliminarily exists in the systems. However, it often happens that the capturing agent of such intermediate is decomposed simultaneously during the course of converting the starting material to the reaction intermediate. Thus, such decomposition blocks the reaction. Overcoming the problem is the second problem.

A third problem to be overcome by the invention is to provide an apparatus appropriately integrated with a measure for giving an energy for promoting the reaction of chemical process in the chemical process using a solvent set. Herein, the given energy excludes the thermal energy given for temperature control and includes at least one of for example photoenergy, electrical energy, sound energy, mechanical vibration energy, electromagnetic energy and radiation energy. In case of giving such energy, traditionally, the reaction sometimes occurs locally or non-uniformly inside the container because photoenergy, electrical energy, sound energy, mechanical vibration energy, electromagnetic energy and radiation energy never uniformly reach the whole reaction container in its entirety or because the distribution of the given energy is not uniform. Accordingly, the processing efficiency and processing yield are poor. So as to solve such problem, importantly, an apparatus capable of allowing the given energy to suitably (uniformly) reach every part of the inside of the reaction container is constituted. The third problem is to provide a constitution of a chemically processing apparatus utilizing a solvent set and having a measure for giving reaction-promoting energy.

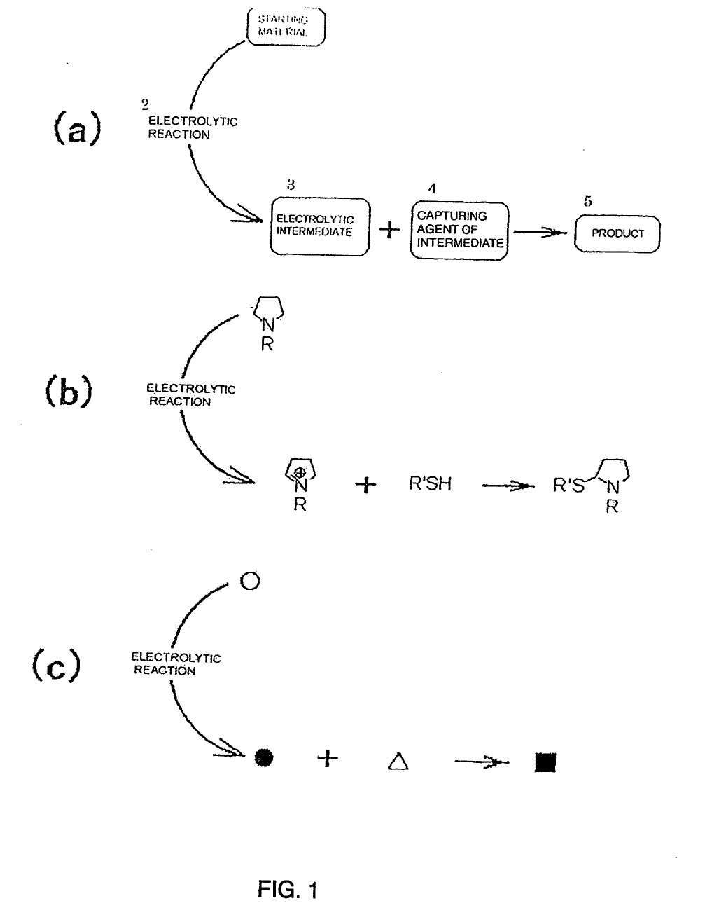

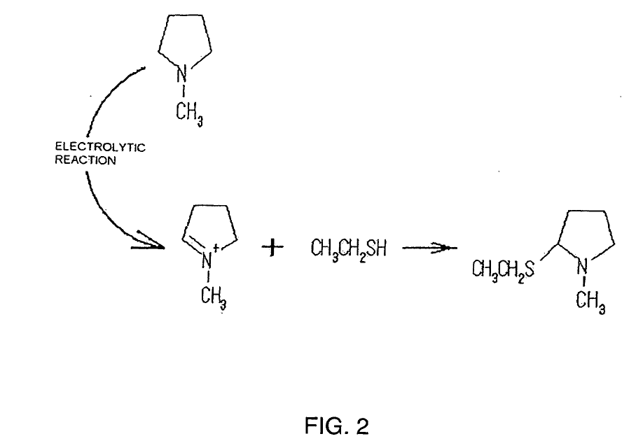

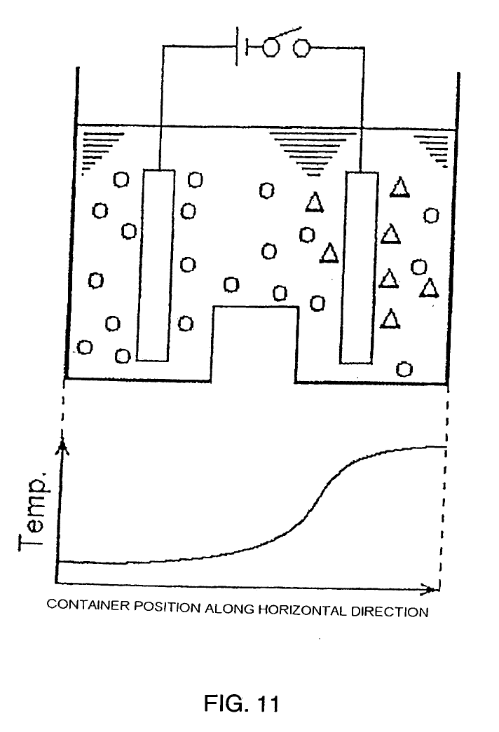

General problems of chemical reaction systems as the second problem are supplementary described in an example of electrolytic reaction. For an electrolytic chemical reaction system, a great number of methods for producing a product (solid square) are used, the methods including once generating a reaction intermediate (solid circle) from a certain starting material (open circle) and then immediately capturing the reaction intermediate with a capturing agent of the intermediate (open triangle), which preliminarily exists in the systems, as shown in FIG. 1. FIG. 1(a) shows a typical flow scheme of the reaction system in an electrochemical (electrolytic) reaction; FIG. 1(b) shows one example of the typical flow scheme; and FIG. 1(c) shows symbols replaced for those in the typical flow scheme (used in FIGS. 11 through 14). FIG. 2 is a figure depicting one example of the typical flow scheme of the electrochemical reaction (FIG. 1(b)) with more specific compounds.

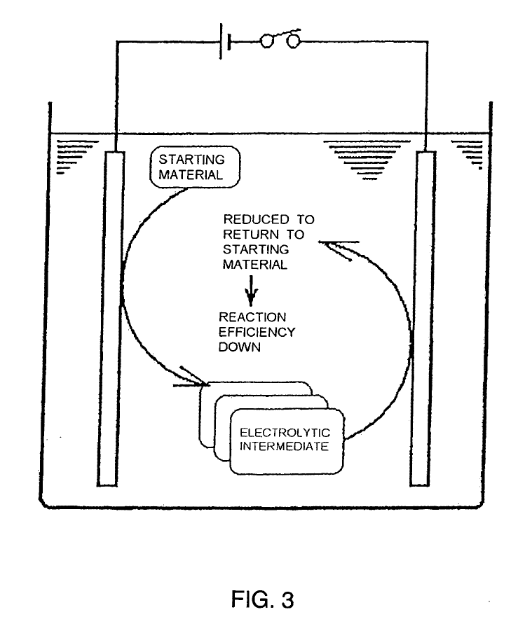

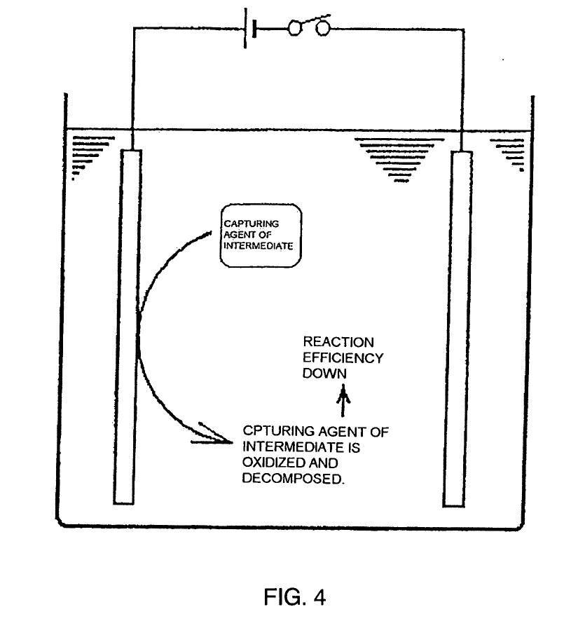

However, frequently, the capturing agent of such intermediate is simultaneously decomposed during the course of converting the starting material to the reaction intermediate, blocking the process of such reaction. In other words, when a starting material is once converted to an intermediate of an electrolytic reaction by the electrolytic reaction at anode, the capturing agent of the intermediate concurrently existing in the system is simultaneously oxidized and decomposed. This scheme is shown in FIG. 4. Additionally, the intermediate of the electrolytic reaction is reduced at the right cathode depicted in FIG. 3, so that the intermediate frequently returns to the starting material. In the related art, separators such as selective ion-permeable membrane are arranged in electrolytic tanks, so as to solve such problem. When such selective separator membrane is added to the reaction system, the diffusion and transfer of the solution is inhibited by the separator, to decrease the reaction efficiency, unpreferably.

So as to solve the second problem, a system should be constituted such that only a starting material can reach the anode, while a capturing agent of intermediate should be allowed to exist locally on the cathode, to progress the intended reaction before the arrival of the intermediate of the electrolytic reaction. The invention described hereinbelow enables partial formation of a compatible state to locate only a specific chemical component at a specific part, by heating one of electrodes or a container around electrodes with a compatible biphasic solution system (solvent set).

### ADVANTAGES OF THE INVENTION

The processing time loss in the change of the chemical process using such solvent set over time with the “change of the temperature of synthesis tank over time” or the time loss involved in the transfer of the chemical process using such solvent set with the “transfer of the places of the solvents between the synthesis tank and the separation tank” in apparatuses of the related art can be overcome by carrying out such reaction in one container.

The invention enables the location of for example a starting material alone at anode and the location of for example a capturing agent of intermediate at cathode, which have never been attained by electrochemical reaction systems of the related art. Thus, the invention enables the constitution of a system capable of progressing an intended reaction in an ideal manner.

The invention provides an apparatus with an appropriately integrated measure for giving an energy for promoting the reaction of chemical process in the chemical process using a solvent set, where the processing efficiency and the processing yield are great without any problems such that given energy cannot uniformly reach every part of the reaction container or the distribution of given energy is not uniform.

### BRIEF DESCRIPTION OF DRAWINGS

(FIG. 1) FIG. 1(a) shows a typical flow scheme of the reaction system in an electrochemical (electrolytic) reaction; FIG. 1(b) shows one example of the typical flow scheme; and FIG. 1(c) shows symbols replaced for those in the typical flow scheme (used in FIGS. 11 through 14).

(FIG. 2) A figure depicting one example of the typical flow scheme of the electrochemical reaction (FIG. 1(b)) with more specific compounds.

(FIG. 3) An explanatory view No. 1 of a problem of electrochemical (electrolytic) reaction.

(FIG. 4) An explanatory view No. 2 of a problem of electrochemical (electrolytic) reaction.

(FIG. 5) Synthetic Example 1 of a compound with Diels-Alder reaction.

(FIG. 6) Synthetic Example 2 of a compound (chroman synthesis) with Diels-Alder reaction.

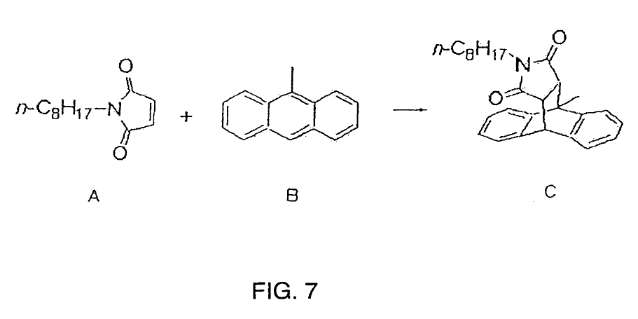

(FIG. 7) Synthetic Example of a compound using liquid catalyst.

(FIG. 8) Constitution view No. 1 with an electrode for electrochemical (electrolytic) reaction being added to the apparatus disclosed in Japanese Patent Application 2002-198242 (integral type of mixing tank and separation tank).

(FIG. 9) Constitution view No. 2 with an electrode for electrochemical (electrolytic) reaction being added to the apparatus disclosed in Japanese Patent Application 2002-198242 (separation type of mixing tank and separation tank).

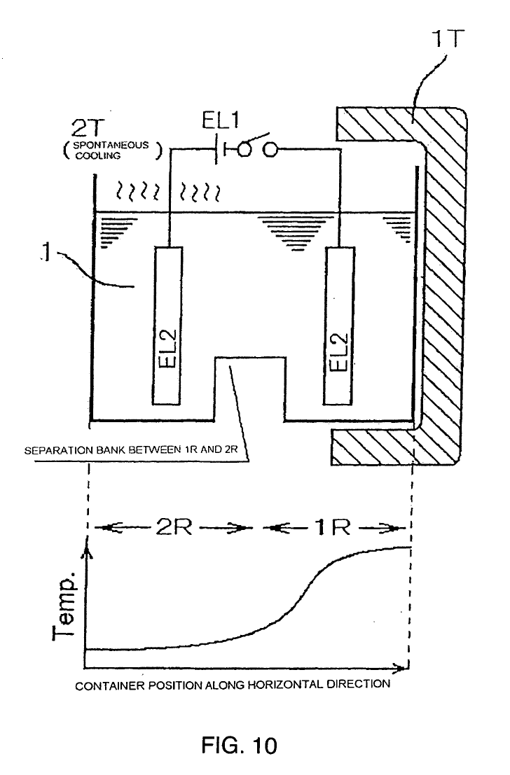

(FIG. 10) An explanatory view of Example 1 of the fundamental constitution of the apparatus of the invention.

(FIG. 11) An explanatory view (No. 1) of the functions of Example 1 (1T and 2T are not shown in the figure).

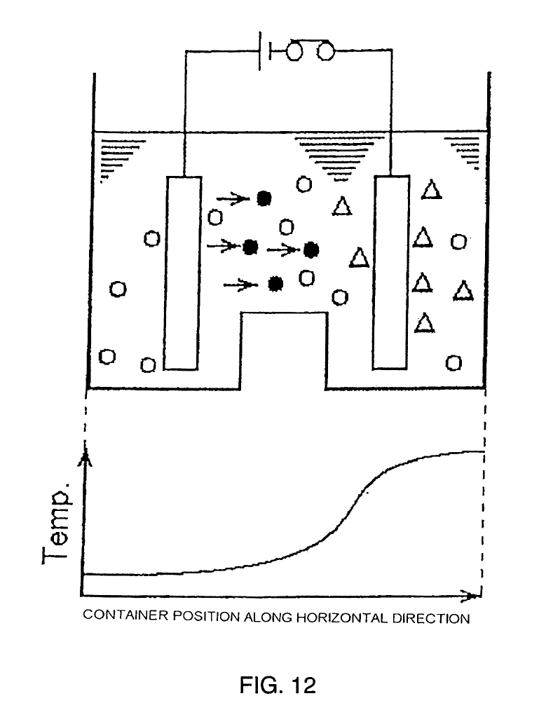

(FIG. 12) An explanatory view (No. 2) of the functions of Example 1 (1T and 2T are not shown in the figure).

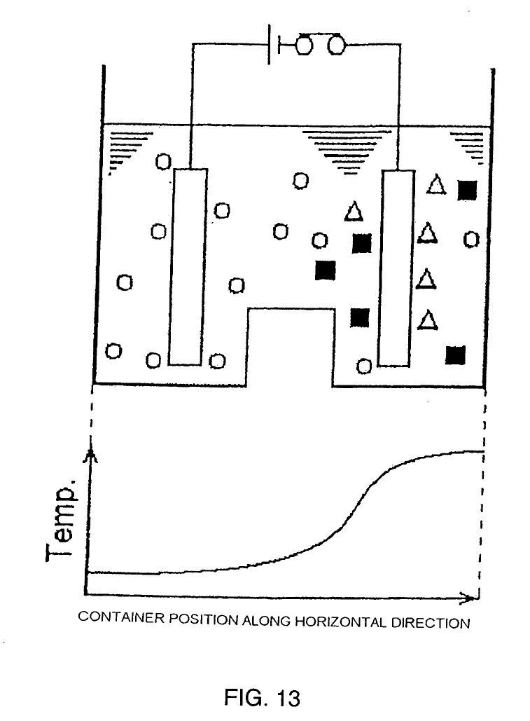

(FIG. 13) An explanatory view (No. 3) of the functions of Example 1 (1T and 2T are not shown in the figure).

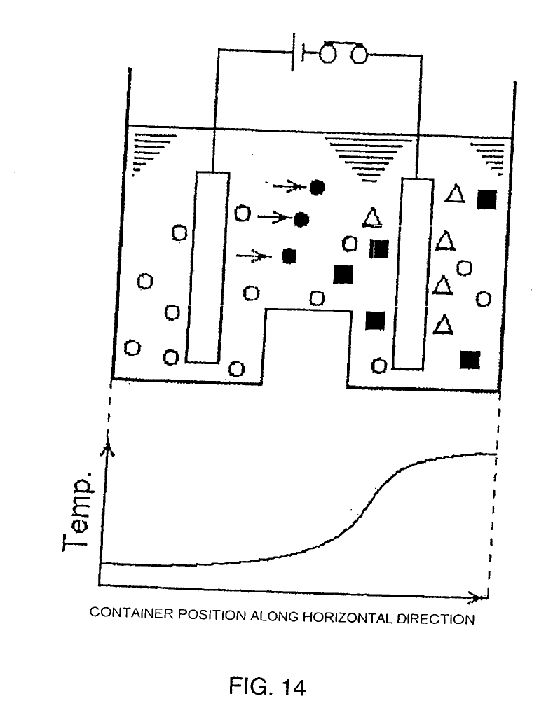

(FIG. 14) An explanatory view (No. 4) of the functions of Example 1 (1T and 2T are not shown in the figure).

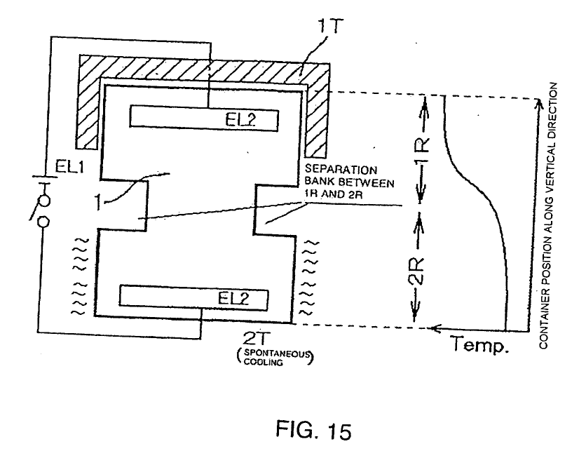

(FIG. 15) An explanatory view (longitudinal type) of Example 2 of the fundamental constitution of the apparatus of the invention.

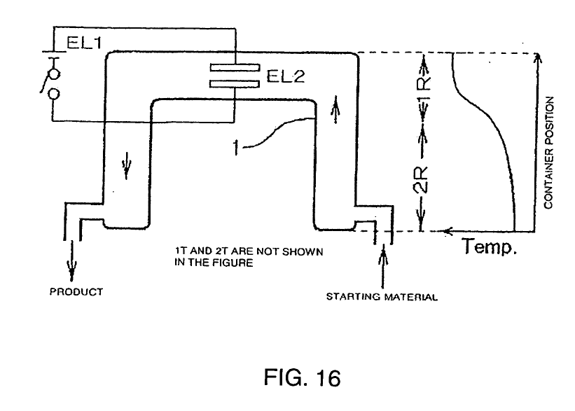

(FIG. 16) An explanatory view (U-character type) of Example 3 of the fundamental constitution of the apparatus of the invention.

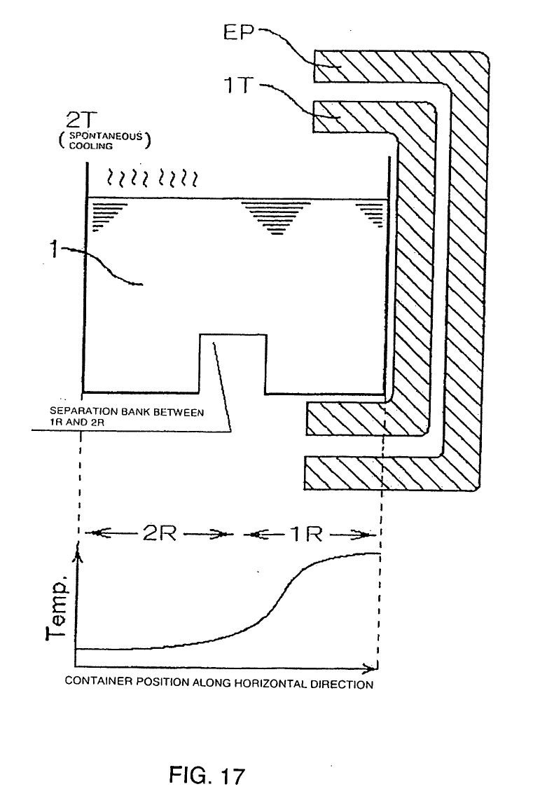

(FIG. 17) An explanatory view of Example 4 of the fundamental constitution of the apparatus of the invention (with an energy-giving measure of crosswise type being arranged).

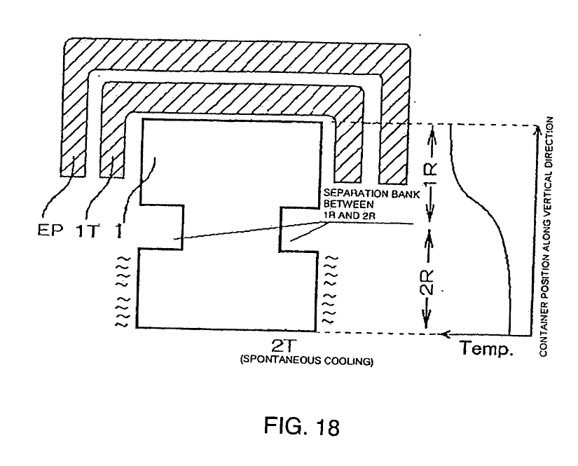

(FIG. 18) An explanatory view of Example 5 of the fundamental constitution of the apparatus of the invention (with an energy-giving measure of longitudinal type).

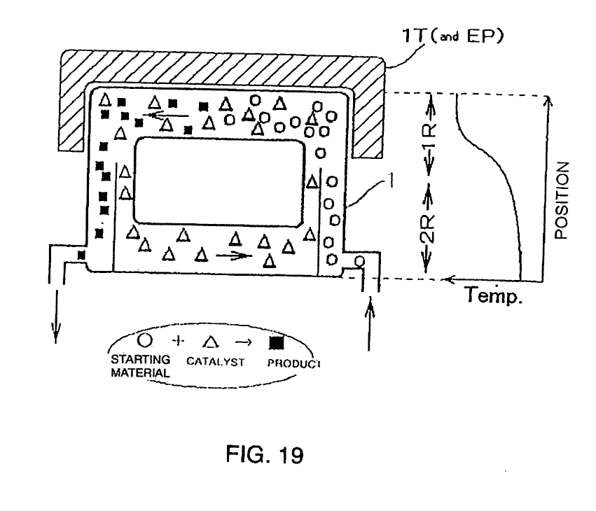

(FIG. 19) An explanatory view of Example 6 of the fundamental constitution of the apparatus of the invention (with a flow measure arranged; an example of catalyst circulation and recycling).

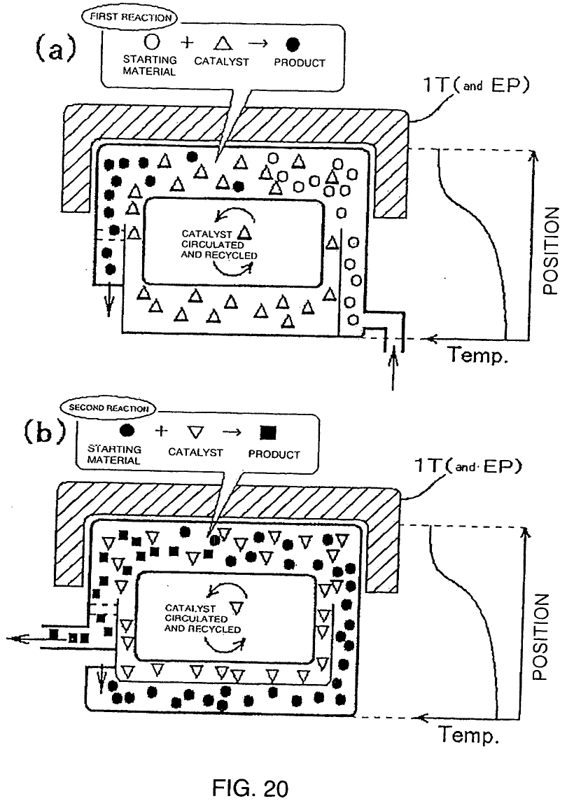

(FIG. 20) An explanatory view of Example 6 of the fundamental constitution of the apparatus of the invention (No. 2; two-step catalyst reaction).

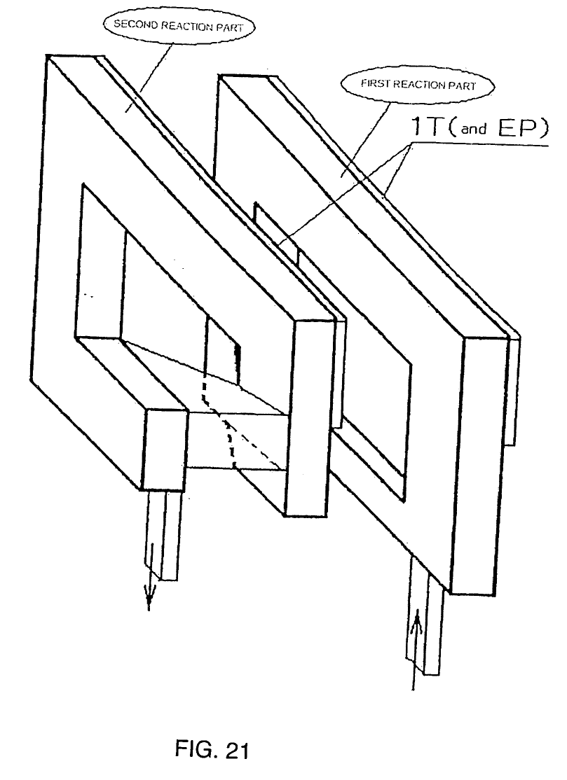

(FIG. 21) An explanatory view of Example 6 of the fundamental constitution of the apparatus of the invention (an example with a two-step reaction chamber in spiral form).

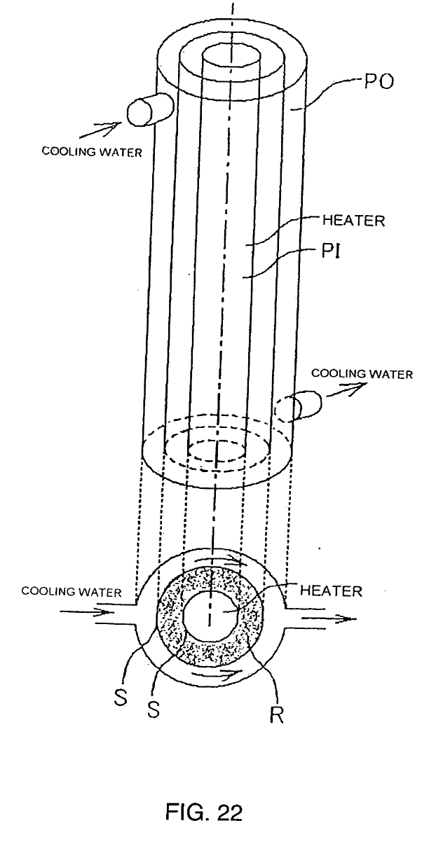

(FIG. 22) An explanatory view of Example 7 of the fundamental constitution of the apparatus of the invention (of a constitution of a double tube structure and with a reaction chamber R where the tube walls of the inner tube and outer tube are separator S).

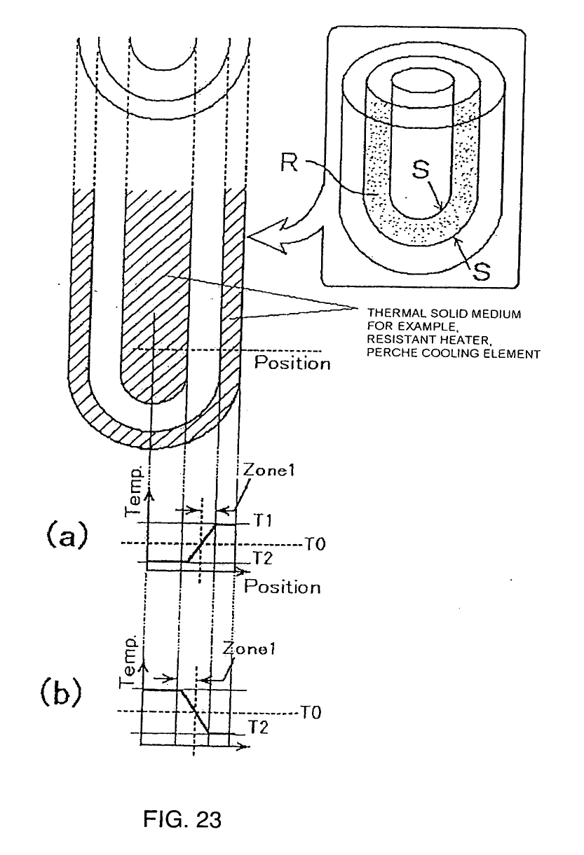

(FIG. 23) An explanatory view of Example 7, where the temperature control of the separator is done with a thermal solid medium.

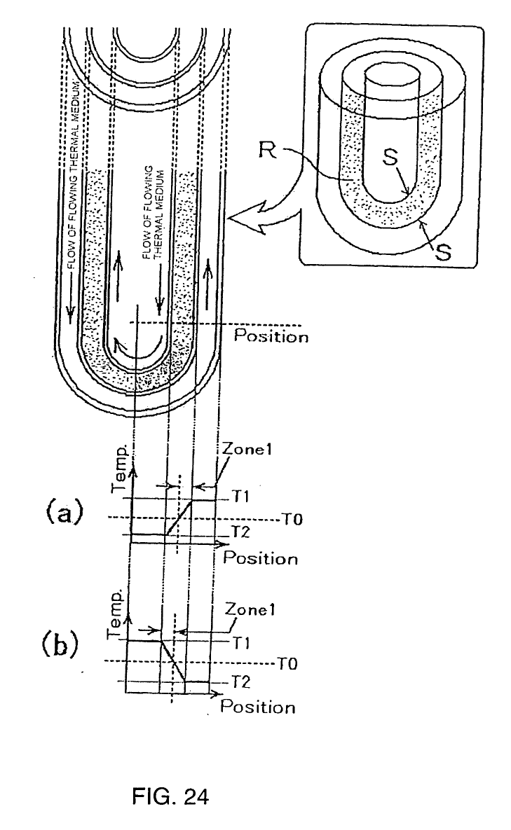

(FIG. 24) An explanatory view of Example 7, where the temperature control of the separator is done with a thermal liquid medium.

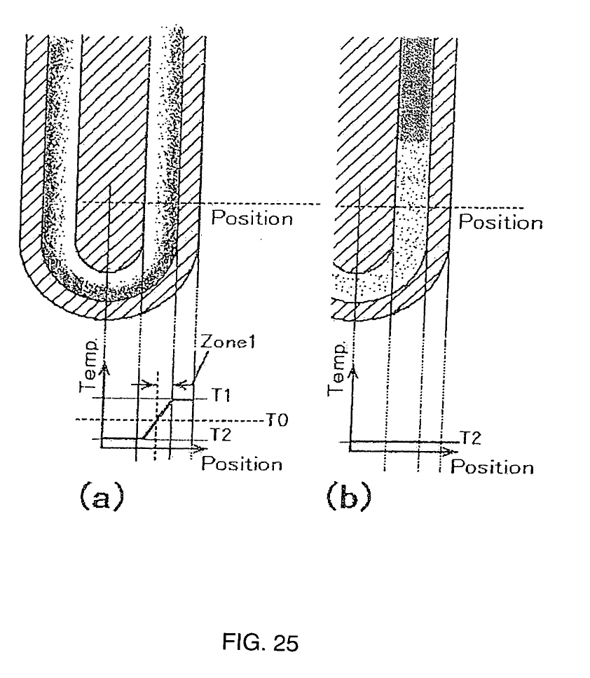

(FIG. 25) An explanatory view of Example 7, which is an explanatory view of the phase-separated state (b) of the whole container before and after chemical process.

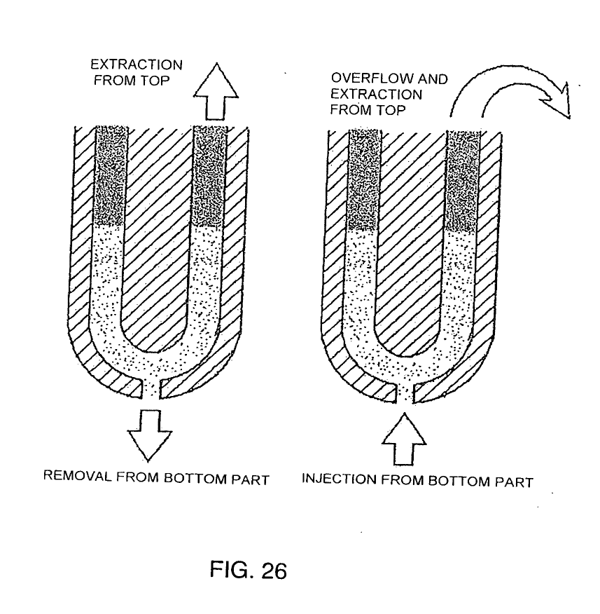

(FIG. 26) An explanatory view of Example 7, which is an explanatory view of the extraction and removal processes in the whole container at phase-separated state.

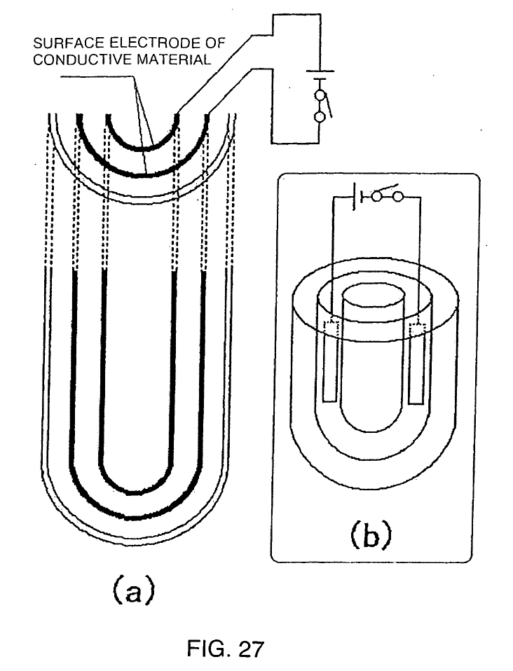

(FIG. 27) An explanatory view of an application of Example 7, where an electrolytic electrode (a measure for giving electrical energy) is arranged.

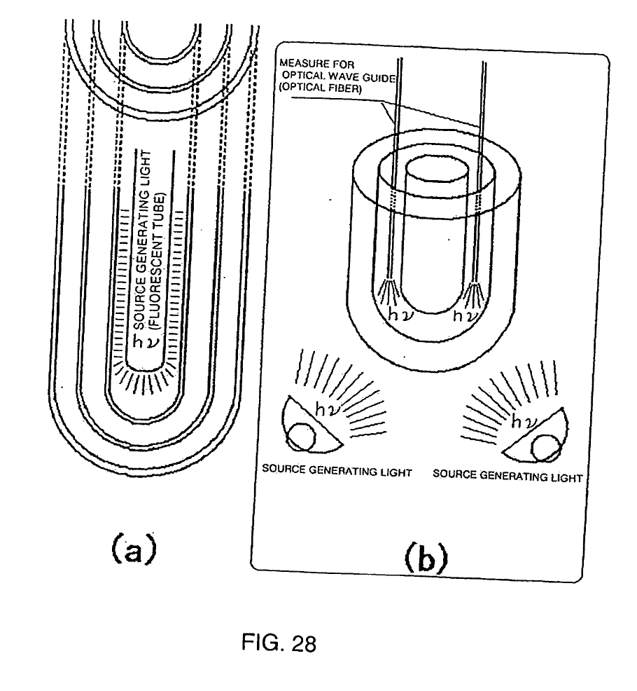

(FIG. 28) An explanatory view of an application of Example 7, where a measure for irradiating light (giving photoenergy) is arranged.

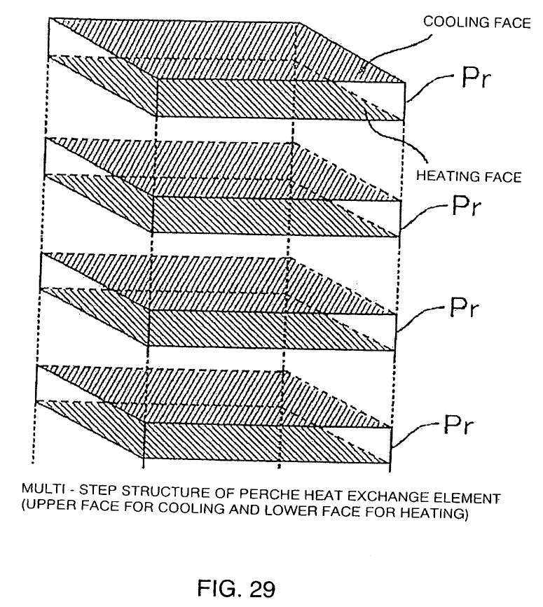

(FIG. 29) An explanatory view of Example 8 of the fundamental constitution of the apparatus of the invention (a parallel plane structure utilizing Perche device).

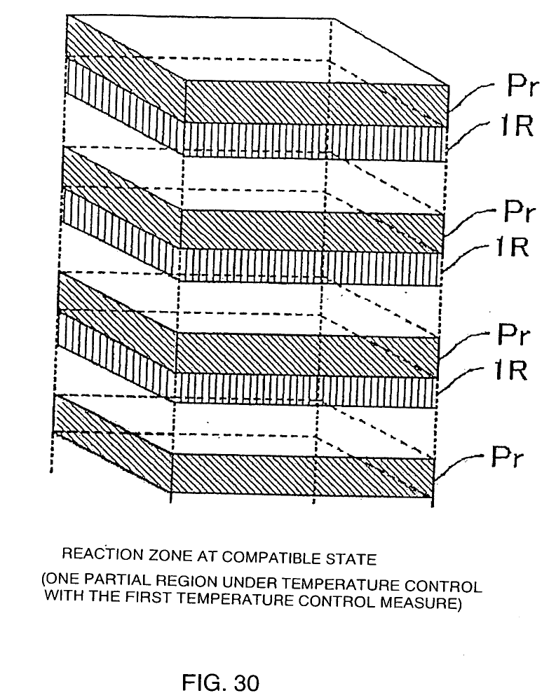

(FIG. 30) A figure depicting 1R on the side of the heating face of the Perche device in the explanatory view of Example 8.

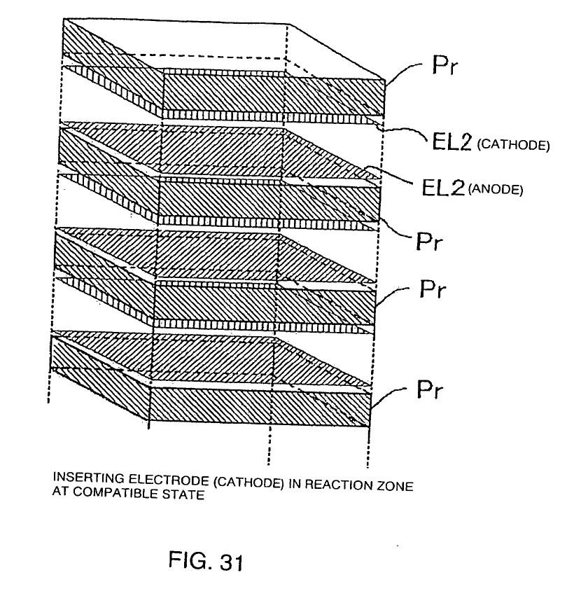

(FIG. 31) An explanatory view of an application of Example 8, where an electrolytic electrode (a measure for giving electrical energy) is arranged.

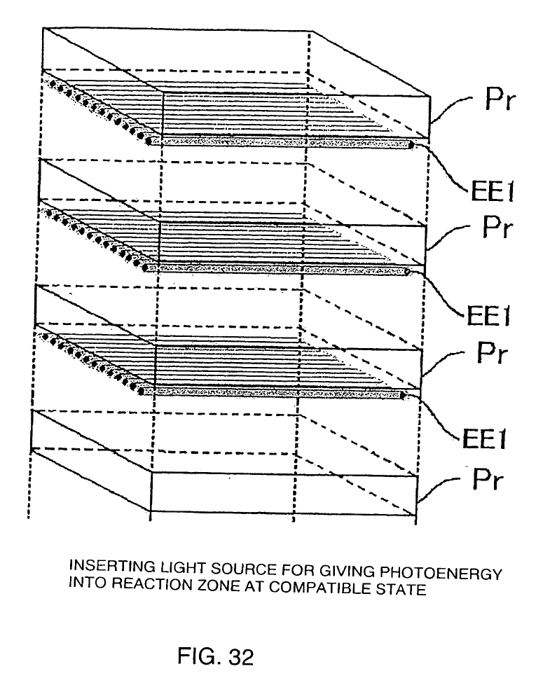

(FIG. 32) An explanatory view of an application of Example 8, where a measure for irradiating light (giving photoenergy) is arranged.

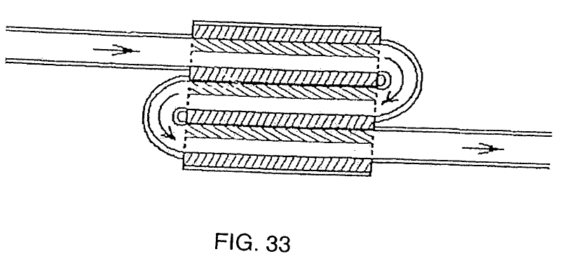

(FIG. 33) An explanatory view of an application of Example 8, where an apparatus of a flow system is used.

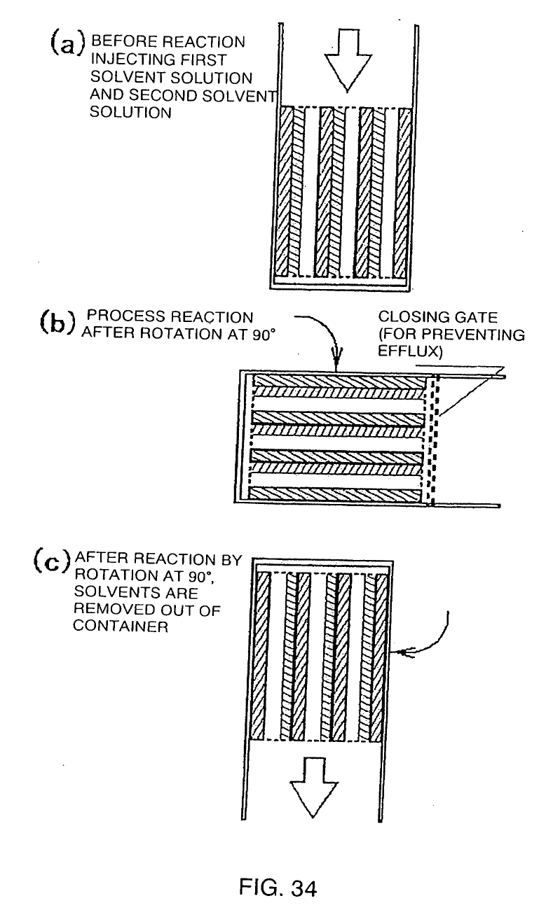

(FIG. 34) An explanatory view of an application of Example 8, where a measure for rotation at 90° each during the introduction of a raw material solution, during the process reaction and during the extraction of the resulting product is combined.

(FIG. 35) An example depicting the change of compatible temperature.

(FIG. 36) An example depicting the change of compatible temperature.

### DESCRIPTION OF SYMBOLS IN DRAWINGS

1: Container for mixing a first solvent solution and the second solvent solution.
1R: One partial region inside the container 1.
1T: First temperature control measure for controlling 1R to a temperature where the first and second solvent solutions are at a compatible state or a higher temperature.
2R: The other partial region inside the container 1.
2T: Second temperature control measure for controlling 2R to a temperature where the first and second solvent solutions are at a separated state, or lower (including the case that these solutions are at a temperature where these solutions are spontaneously at a separated state due to atmospheric cooling, or lower).
3: Mixing tank for mixing the first solvent solution and the second solvent solution together.
4: Preparation tank of second solvent solution B12 prepared by dissolving amino acids after preliminary treatment for bonding in the second solvent.
5: Measure for supplying the second solvent solution B12 to the mixing tank.
5a: Part of 5, which is a transfer conduit (tube) of the second solvent solution.
5b: Part of 5, which is for example a measure for closing and opening conduits (valve, etc.) and transfer pump.
6: Temperature control measure of synthesis tank 3.
6a: Temperature control measure in the control (heating) of the first and second solvent solutions to a temperature where the solutions are at a compatible state.
6b: Temperature control measure in the control (cooling) of the first and second solvent solutions to a temperature where the solutions are at a phase-separated state.
7: Measure for removing the second solvent solution after determining the volume thereof on the basis of the interface position determined with 20.
7a: Part of 7, which is for example a conduit (tube) for removing the second solvent solution, a measure for closing and opening the conduit (valve, etc.), pump and the like.
12: Amino acid after preliminary treatment for bonding, which is preliminarily bound with a protective group such as Fmoc at the N end.
16: Measure for transferring the first and second solvent solutions at a compatible state in the mixing tank.
16a: Part of 16, which is for example a measure for closing and opening the conduit (valve, etc.), pump or the like.
17: Separation tank for making the first and second solvent solutions at a phase-separated state.
18: Measure for removing the second solvent solution from the separation tank 17 after determining the volume thereof.
18a: Part of 18, which is for example a measure for closing and opening the conduit (valve, etc.) or transfer pump.
20: Measure for detecting the interface between the first solvent solution and the second solvent solution.
20a: Probe (probe) of sensor of physico-chemical properties of solvent as inserted in the synthesis tank 3.
A: First solvent
A0: First solvent solution dissolving optional substance therein.
B: Second solvent
B0: Second solvent solution dissolving optional substance therein.
B12: Second solvent solution dissolving 12 in the second solvent.
EE: Measure for giving photoenergy to promote the reaction of chemical process.
EE1: Photo-irradiator
EE2: Optical fiber
EE3: Optical wave guide
EL: Measure for giving electrical energy to promote the reaction of chemical process.
EL1: Electric source
EL2: Electrode for electrochemical reaction
EP: Measure for giving at least one of sound energy, mechanical vibration energy, electromagnetic energy, and radiation energy to promote the reaction of chemical process.
PI: Inner tube of container of double-tube structure
PO: Outer tube of container of double-tube structure
Pr: Plane heat exchanger element using Perche device (cooling surface, heating back face)
R: Reaction chamber
S: Separator
Position: Horizontal axis showing the position of the cross-sectional face of apparatus or line showing the position of the cross-sectional face of apparatus.
T0: Temperature where compatible state and separated state exchange from each other.
T1: Temperature where the first solvent solution and the second solvent solution are at a compatible state, or higher.
T2: Temperature where the first solvent solution and the second solvent solution are at a phase-separated state, or lower.
TC1: First temperature control measure for controlling the temperature of one partial region to a temperature of compatible state, or higher.
TC2: Second temperature control measure for controlling the temperature of the other partial region to a temperature of phase-separated state, or lower.
Temp: Vertical axis showing temperature.
Zone1: Partial region under control of temperature with the first temperature control measure inside container (showing 1R)

### BEST MODE FOR CARRYING OUT THE INVENTION

The invention is a chemically processing apparatus using a combination of a first solvent and a second solvent, where the compatible state and the separated state are reversibly changeable in a manner dependent on the temperature, the apparatus including a container for mixing together a first solvent solution prepared by dissolving a starting material of a chemical process and/or a substance to be involved in a reaction of the chemical process in a first solvent and a second solvent solution prepared by dissolving the starting material of the chemical process and/or the substance to be involved in the reaction of the chemical process in a second solvent, a first temperature control measure for controlling the temperature of one partial region inside the container to a temperature where the first solvent solution and the second solvent solution are at a compatible state or a higher temperature, and a second temperature control measure for controlling the temperature of the other partial region inside the container to a temperature where the first solvent solution and the second solvent solution are at a phase-separated state or a lower temperature.

Herein, the “one partial region” is read as it is, where “one” means an optional one. Thus, the one partial region is the region of an optional part inside the container. Another optional region which is not the one partial region is referred to as the other partial region. Additionally, the “container” may satisfactorily give any place for mixing together the first and second solvent solutions and includes for example a reaction chamber (tube) of a flow system, which can give a place for mixing together the first and second solvent solutions, other than general reaction tanks.

The essence of the invention resides in simultaneously carrying out the compatible and separation procedures using a solvent set in “one” container (or in a reaction chamber of one flow system) based on a conceptual conversion, although the procedure has been carried out in the related art by the “change of the temperature of synthesis tank over time” or by the “transfer of the places of solvents between synthesis tank and separation tank”. Therefore, a temperature distribution is arbitrarily prepared inside the container. Specifically, the temperature distribution is expressed in one partial region (1R) under temperature control with the first temperature control measure and the other partial region (2R) under temperature control with the second temperature control measure, where the individual intended temperature control levels are at a compatible temperature or higher and a separable temperature or lower, respectively.

By such constitution, no change of states, namely no change from compatible state to separated state, again back to compatible state over time or no change of states by transfer of places, namely no change from compatible (mixing) tank to separation tank, again back to compatible (mixing) tank is needed, so that such chemical process can be progressed just in one container. Thus, such apparatus is preferable as a processing apparatus using a solvent set. It is needless to say that the loss of processing time due to the “change of the temperature of synthesis tank over time” as the first problem or the loss due to transfer time for the “transfer of the places of solvents between synthesis tank and separation tank” can be overcome.

The apparatus for solving the second problem is shown in FIG. 10, where an electrolytic reaction apparatus is shown as one example. FIG. 10 is one example of the fundamental constitution of the apparatus of the invention. In the figure, a graph of the temperature distribution in the container 1 along horizontal direction (vertical position is arbitrary) is depicted. Herein, the cathode side is heated with first temperature control measure 1T. Therefore, the first and second solvent solutions reach a compatible state in one partial region (represented as 1R on the temperature graph) around the cathode inside the container 1. The other partial region (represented as 2R on the temperature graph) is around the anode inside the container 1. Second temperature control measure 2T is not essentially needed in case that the solutions reach a separation temperature by spontaneous cooling via atmospheric convection, contact heat transmission and radiation cooling. The separation bank between 1R and 2R preferably exists. However, the separation bank may or may not be arranged.

A solvent set and a capturing agent of intermediate (open triangle) can be selected such that the capturing agent of intermediate is soluble in the first solvent but hardly soluble in the second solvent (otherwise, soluble in the second solvent but hardly soluble in the first solvent). In that case, the capturing agent of intermediate (open triangle) should be distributed in the container such that the capturing agent may be more in the compatible part of the first and second solvents under temperature control but may be less in the remaining regions. The state is shown in FIG. 11. In such manner, the decomposition of the capturing agent of intermediate (open triangle) at anode as described in the supplementary description of the second problem of the related art never occurs. Additionally because the capturing agent of intermediate (open triangle) resides highly locally at cathode, the probability of the occurrence of a reaction working for the reaction intermediate (solid circle) from the electrolysis of the starting material (open circle) at the anode to return to the initial starting material is greatly decreased. The schematic view of the reaction progress is shown in FIGS. 12, 13 and 14.

A solvent set and a starting material (open circle) can be selected such that the reaction intermediate (solid circle) from the electrolysis of the starting material (open circle) is soluble in the first solvent but hardly soluble in the second solvent (otherwise, soluble in the second solvent but hardly soluble in the first solvent). Contrary to FIGS. 11 through 14, the vicinity of the anode is selected as one partial region (1R) for heating with first temperature control measure 1T. In such manner, the reaction intermediate (solid circle) is reduced at cathode, so that the reaction intermediate returns to the starting material at a greatly decreased frequency (not shown in the figures). As described above, the apparatus of the invention enables the localization of the starting material at the anode and the localization of the capturing agent of intermediate at the cathode. Thus, the electrolytic intermediate can highly efficiently be captured, to efficiently progress the intended reaction.

A constitution such that anode and cathode both are used as one partial region (1R) is also satisfactory. In this case, compounds are localized on both the electrodes, so that the concentration of a compound to be involved in the reaction can be adjusted in a manner preferable for the promotion of the reaction, by modifying the control temperature of the anode and cathode.

FIGS. 11 through 14 show a constitution where the first temperature control measure 1T heats the solvent temperature from the outside of the container 1. Additionally, the constitution of heating electrode EL2 itself may satisfactorily be selected. In this case, the electrode may be temperature-controlled in a constitution of integrating the electrolytic face of the electrode and other resistant heating units insulated with an insulation material together.

As described above, one of the electrodes or the container around the electrodes is temperature-controlled in the apparatus of the invention. Thus, a compatible state is partially formed inside the container, to enable the localization of only a specific chemical component at a specific part, which is never realized in chemical reaction apparatuses of the related art.

FIG. 15 shows an explanatory view (vertical type) of Example 2 of the fundamental constitution of the apparatus of the invention. It is needless to say that because the temperature of 1R is higher than the temperature of 2R, a constitution is preferable such that one partial region (1R) under temperature control with the first temperature control measure is positioned upward the other partial region (2R) under temperature control with the second temperature control measure (claim 5).

FIG. 16 is an explanatory view (U-character type; the temperature control measure is not shown) of Example 3 of the fundamental constitution of the apparatus of the invention, which is an example of a reaction apparatus of a flow system. The flow system contains a flow measure of solvent solutions, which works for first and second solvent solutions to flow from one partial region (1R) to the other partial region (2R) and/or for the first and second solvent solutions to flow from the other partial region (2R) to one partial region (1R) (claim 10). The flow measure of such flow system is not shown in the figure. Various pumps may be used for the flow system.

In FIG. 16, an example with a measure for giving electrical energy being arranged to promote the reaction of chemical process and specifically an example with arranged electric source EL1 and electrode EL2 for electrochemical reaction are shown. As shown above, a measure for giving energy to give optional energy to promote the reaction of chemical process may be arranged in one partial region (1R) under temperature control with the first temperature control measure (1T) (claim 3).

The optional energy includes at least one of photoenergy, electrical energy, sound energy, mechanical vibration energy, electromagnetic energy and radiation energy, except thermal energy to be given for temperature control (claim 4). The energy can be given with those shown in FIG. 17 (the explanatory view of Example 4 of the fundamental constitution of the apparatus of the invention (an energy-giving measure of a crosswise type in arrangement) or in FIG. 18 (the explanatory view of Example 5 of the fundamental constitution of the apparatus of the invention (an energy-giving measure of a longitudinal type in arrangement), with no specific limitation to the apparatus of the flow system as shown in FIG. 16.

The invention is applicable to catalytic reaction processes common in chemical processes. In other words, a catalyst for the reaction of chemical process may be arranged in one partial region (1R) under temperature control with a first temperature control measure, so as to promote the reaction of chemical process (so as to lower the energy barrier of the reaction) (claim 2).

FIG. 19 also shows an example of the use of a catalyst in such flow system (the explanatory view of Example 6 of the fundamental constitution of the apparatus of the invention (as arranged with a flow measure; an example of catalyst circulation and recycling)). In this case, the catalyst is a substance to be involved in the reaction of chemical process and is a catalyst soluble in a first solvent but hardly soluble in a second solvent (otherwise, a catalyst soluble in the second solvent but hardly soluble in the first solvent), while the reaction of chemical process is a synthetic reaction of a compound, utilizing the catalyst (claim 11).

In FIG. 19, the catalyst (open triangle) and the product (solid square) are separated in the vicinity of the outlet of the container, while only the first solvent (the second solvent) may satisfactorily be circulated for recycling. As shown in the figure, measure EP for giving at least one of sound energy, mechanical vibration energy, electromagnetic energy and radiation energy so as to promote the reaction of chemical process may be arranged in combination with the first temperature control measure 1T.

FIG. 20 shows an explanatory view of Example 6 of the fundamental constitution of the apparatus of the invention (No. 2; two-step catalyst reaction). This is an example of an application of the flow system to a two-step catalytic reaction. A first reaction catalyst (open triangle) and a second reaction catalyst (inverted open triangle) are individually soluble in one of the first and second solvents but hardly soluble in the remaining one of the solvents. In the vicinity of the individual outlets of the first reaction part and the second reaction part, they are separated, while only the first solvent (second solvent) may be circulated for recycling. A specific schematic view of the apparatus is shown in FIG. 21 (the explanatory view of Example 6 of the fundamental constitution of the apparatus of the invention (an example with a two-step reaction chamber in spiral form)).

So as to overcome the third problem, a constitution such that one partial region (1R) or the other partial region (2R) is in the vicinity of the inner wall of the container while the inner wall of the container or the outer wall of the container is temperature-controlled with a first or second temperature control measure is preferable as an apparatus integrated preferably with an energy-giving measure to promote the reaction of chemical process at the chemical process utilizing a solvent set, namely the measure so as to eliminate energy unbalance (claim 6).

Furthermore, a constitution is preferable, including one or more reaction chambers (R) with one or more separators (S) inside the container, where one partial region or the other partial region is in the vicinity of the separators (S) of the reaction chamber and the separators are temperature-controlled with a first or second temperature control measure (claim 7). The reason is that energy is frequently given in the reaction chamber segregated with the separators. Such reaction chamber has a shape and a size designed so as to uniformly give the energy.

<Multi-Tube Structure>

FIG. 22 is an explanatory view of Example 7 of the fundamental constitution of the apparatus of the invention (a constitution of a double-tube structure and with a reaction chamber R where the tube walls of the inner tube PI and outer tube PO are separator S). R is reaction chamber; and S is separator. In this example, reaction chamber R is arranged in the space between the inner tube PI and the outer tube PO. The tube walls of the inner tube PI and the outer tube PO are separator S. Arranging a heater on the side of the inner tube and allowing cooling water to flow inside the outer tube, temperature is controlled. In other words, the container is of a double-tube structure comprising the inner tube and the outer tube arranging the inner tube inside, while the separators are a part or the whole of the tube walls of the inner tube and the outer tube (claim 8). A multi-tube structure of triplet tube, quadruplet tube and quintuplet tube may be constituted, where such double-tube structure is alternately nested.

FIG. 23 is an other explanatory view of Example 7, where the separators S of the reaction chamber R are temperature-controlled with a thermal solid medium. As shown in the figures (a) and (b), the separator on the side of the outer tube may be a reaction zone (Zone 1, 1R) for compatible preparation (a) or the separator on the side of the inner tube may be a reaction zone for compatible preparation (b). In the figure, Position represents the horizontal axis showing the position of the cross-sectional face of the apparatus or the line showing the position of the cross-sectional face of the apparatus; T0 represents the temperature where compatible state and separated state exchange from each other; T1 represents the temperature where the first solvent solution and the second solvent solution are at a compatible state or a higher temperature; T2 represents the temperature where the first solvent solution and the second solvent solution are at a phase-separated state or a lower temperature; TC1 represents first temperature control measure for controlling the temperature of one partial region to a temperature of compatible state or a higher temperature; TC2 represents second temperature control measure for controlling the temperature of the other partial region to a temperature of phase-separated state or a lower temperature; Temp represents the vertical axis showing temperature; and Zone1 represents one partial region under temperature control with the first temperature control measure inside the container (showing 1R).

FIG. 24 is an explanatory view of Example 7, where the separators are temperature-controlled with a thermal liquid medium. FIG. 25 is an explanatory view of Example 7, which is an explanatory view of the phase-separated state (b) of the whole container before and after chemical process. While the container is entirely kept at the temperature of phase separation, or a lower temperature, the state in FIG. 25 (b) is prepared from the state in FIG. 25 (a), to extract the product and remove unnecessary matters. The extraction and the removal are done as shown in FIG. 26 (the explanatory view of Example 7, which is an explanatory view of the extraction and removal processes in the whole container at phase-separated state). In other words, the extraction is done from the top, while the removal is done from the bottom part. Otherwise, a solvent solution is given and injected from the bottom part to make the solution overflow from the top, for extraction (removal).

FIG. 27 is an explanatory view of an application of Example 7, where an electrolytic electrode (a measure for giving electrical energy) is arranged. As shown in FIG. 27 (a), an electrode is preferably arranged on the surface of the separator by known techniques for forming surface electrode, such as surface coating of the separator with a conductive material. The reason is that compared with a constitution of inserting an electrode as shown in FIG. 27 (b), the formation of an electrode on the separator makes the distance between electrodes equal, so that the reaction uniformity is greater.

FIG. 28 is an explanatory view of an application of Example 7, where a measure for irradiating light (giving photoenergy) is arranged. In this case, an outer light source or an optical fiber as shown in FIG. 28 (b) may be used. However, photoenergy may possibly be more uniform by optical guiding using the inner tube or the outer tube as an optical wave guide of quartz glass. It is needless to say that a light source may be inserted inside the inner tube as shown in FIG. 28 (b). In other words, the energy to be given is photoenergy, while the measure for giving photoenergy comprises a source generating light and an optically transmitting substance as a part or the whole of a container material, or an optically wave guide measure with a wave guide end in one partial region inside the container, so that the photoenergy from the source generating light is given through the optically transmitting substance or the optically wave guide measure to the one partial region (claim 13).

<Parallel Plane Combination Structure>

A mode for carrying out the invention is a constitution with a container structure where plural planes form a space, while the separators are a part or the whole of the parallel planes (claim 9). As a preferable example thereof, a constitution using a heat exchange element using Perche device is shown. The heat exchange element using the known Perche device is in a plane shape, where the top face works for cooling and the lower face is for heating. The heat exchange element with the Perche device can control temperature at high precision. Embodiments of the invention using the element are now described below.

FIG. 29 is an explanatory view of Example 8 of the fundamental constitution of the apparatus of the invention (a parallel plane structure utilizing Perche device), where heat exchange element Pr using Perche device is a plane shape, where the top face works for cooling and the lower face generates heat. Plural such elements are overlaid together at an interval. FIG. 30 is an explanatory view of Example 8 and is a figure depicting the formation of 1R on both the sides of the heating face of the Perche device. Not shown in the figure, 2R is formed in the space between the parallel planes below 1R. In this example, reaction can progress at R including 1R and 2R at a constant distance and at a controlled temperature.

FIG. 31 is an explanatory view of an application of Example 8, where an electrolytic electrode (a measure for giving electrical energy) is arranged and FIG. 32 is an explanatory view of an application of Example 8, where a measure for irradiating light (giving photoenergy) is arranged. Even in these application examples, preferably, a constant energy can be given while reaction can progress at a controlled temperature.

FIG. 32 is an explanatory view of Example 8, where an apparatus of a flow system is used. U-turn flow flowing sequentially in each of the spaces may satisfactorily be arranged.

In case of carrying out a process with a temperature distribution in Example 8, the space is preferably horizontal. However, it is not easy to introduce a raw material solution in the reaction cell structure of the parallel planes. When the space is vertical, however, it can readily be introduced. When the space is vertical, similarly, product extraction and the removal of unnecessary matters can be done readily. As shown in FIG. 34 (the explanatory view of an application of Example 8 in combination with a measure for rotation at 90° each during the introduction of a raw material solution, during the process reaction and during the extraction of the resulting product), thus, a rotation measure of the reaction cell structure of the parallel planes is preferably arranged in combination.

<Chemically Processing Apparatus for Use in Peptide Synthesis>

Additionally, the invention is a chemically processing apparatus among the apparatuses described above, where the substance to be involved in the reaction of a chemical process is a carrier compound of a peptide soluble in either one of first and second solvents and hardly soluble in the remaining one of the first and second solvents and the reaction of the process is a peptide synthesis reaction for binding sequentially amino acids onto the carrier compound.

The apparatus is used for a liquid-phase peptide synthesis method using a solvent system capable of reversibly controlling the state to the compatible state and the phase-separated state by controlling the temperature, where a carrier group derived from a compound increasing the solubility in one of solvents composing the solvent system capable of controlling the state or in mixture solvent A is used as the residue into which the amino acid residue at the carboxyl end of a peptide to be synthetically prepared is introduced; a combination of the solvent or mixture solvent A with the carrier group is used, which can increase the solubility of a peptide initiator compound with the amino acid residue at the carboxyl end of the peptide to be synthetically prepared being bound to the carrier group and a compound prepared by sequentially introducing amino acids into the peptide initiator compound to extend the peptide chain in the solvent or mixture solvent A; a solvent is used as the other solvent or mixture solvent B to be used in combination with the solvent or mixture solvent A, which can preferentially dissolve various amino acids for use in the extension of the peptide chain at the temperature for forming the compatible state or a lower temperature and can form a solvent at a compatible state with A at the temperature for forming the compatible state or a higher temperature to dissolve the peptide initiator compound, to sequentially substitute B dissolving a protected amino acid with a protective group bound on various α-amino groups therein, at a phase-separated state to heat the resulting product at a temperature for providing a compatible state after the substitution to sequentially bind the amino acids.

The solvent system for use with the apparatus comprises two or more types of single organic solvents or mixture organic solvents capable of reversibly forming a uniformly compatible mixture solvent state and a separated solvent state with separated plural phases at least depending on a slight change of a temperature, where one of the organic solvents or mixture organic solvents dissolves the peptide initiator compound and a compound prepared by sequentially binding amino acids to the initiator compound to extend the peptide chain at the separated solvent state but never dissolves the amino acids to be bound and where the remaining one of the organic solvents or mixture organic solvents dissolves amino acids to be bound at the separated solvent state but never dissolves the peptide initiator compound and a compound prepared by sequentially binding amino acids to the initiator compound to extend the peptide chain at the separated solvent state. The solvent system essentially has the characteristic properties described above.

For the apparatus, importantly, a compound is selected as the peptide initiator compound, which can get increased solubility in one of single organic solvents or mixture organic solvents but is never dissolved in the remaining one of the single organic solvents or mixture organic solvents to be used in combination with the one of single organic solvents or mixture organic solvents, at separated solvent state. As such, compounds containing a residue represented by the general formula A and a hydrocarbon group with 10 or more carbon atoms in the backbone are selected.

### General Formula A

In the general formula A, L₁ represents single bond binding to hydroxyl group, thiol group, amino group or carbonyl group binding to amino acid, an atomic group binding to the hydroxyl group, thiol group, amino group or carbonyl group, or an atomic group binding to the dotted line to form a bicyclic condensed aromatic ring; the dotted line represents a binding to H or an atomic group binding to the L₁ to form the condensed aromatic ring; X represents O, S, N, ester group, sulfide group or imino group; R represents a hydrocarbon group with 10 or more carbon atoms, which may contain O, S, or N as a binding atom that can increase the solubility in cycloalkane solvents. “n” is an integer of 1 to 5.

Specific examples of the general formula A include the following compounds of the general formula B.

### Group of General Formula B

In the individual general formulas, X, R and n represent the same as in the general formula A. Q represents single bond or a hydrocarbon group; R₂ represents hydroxyl group, thiol group, amino group or carbonyl group binding to amino acid; and R₃ and R₄ are groups of the following general formula C.

### General Formula C

R₅ represents hydroxyl group, thiol group, amino group or carbonyl group binding to amino acid.

As the amino acid for use in the liquid-phase peptide synthesis with the apparatus, protected amino acids for use in the solid-phase peptide synthesis of related art, for example Fmoc (9-fluorenylmethoxycarbonyl)-amino acid, Boc (t-butoxycarbonyl)-amino acid, Cbz (benzyloxycarbonyl)-amino acid can be used.

### EXAMPLE 1

The apparatus of the invention is readily selected as an apparatus for the Diels-Alder reaction process shown in FIGS. 5 and 6. In an example of a Diels-Alder reaction process under mixing with a catalytic phase and separation, the reaction of FIG. 7 is readily carried out with the apparatus of a flow reaction system in accordance with the invention, for example the apparatuses of FIGS. 16, 19, 20, 21, and 33. In other words, compound A (10 mmol) of FIG. 7 is dissolved in 100 ml of 10 mM lithium perchlorate·nitroethane/nitromethane solution (nitroethane: nitromethane=1:3) prepared as a catalyst solution and is then placed in the apparatus of the flow reaction system. Compound B (10 mmol) of FIG. 7 is preliminarily dissolved in 100 ml of cyclohexane, and is then injected from the flow inlet at a constant flow (preset such that the passing time of the solution through the reaction layer part might be 20 minutes). After completion of the injection of the solution, pure cyclohexane is continuously injected. The temperature of the reaction layer (uniform layer) is controlled to 70° C., while the temperature of the layer separated into two phases is controlled to 30° C. By recovering the cyclohexane solution eluting from the outlet of the flow system, the product C of FIG. 7 as an objective can be obtained (Yield: 90%). By freshly supplying compound A and compound B, 10 mM lithium perchlorate·nitromethane solution (catalyst solution) could be recycled.

1. A chemical processing apparatus using a combination of a first solvent and a second solvent, where the compatible state and the separated state are reversibly changeable in a manner dependent on the temperature, the apparatus including a container for mixing together a first solvent solution prepared by dissolving a starting material of a chemical process and/or a substance to be involved in a reaction of the chemical process in a first solvent and a second solvent solution prepared by dissolving the starting material of the chemical process and/or the substance to be involved in the reaction of the chemical process in a second solvent, a first temperature control measure for controlling the temperature of one partial region inside the container to a temperature where the first solvent solution and the second solvent solution are at a compatible state or a higher temperature, and a second temperature control measure for controlling the temperature of the other partial region inside the container to a temperature where the first solvent solution and the second solvent solution are at a phase-separated state or a lower temperature.

2. The chemical processing apparatus according to claim 1, where a catalyst for the reaction of the chemical process is arranged in one partial region under temperature control with the first temperature control measure.

3. The chemical processing apparatus according to claim 1, where a measure for giving energy to give energy to promote the reaction of the chemical process is arranged in one partial region under temperature control with the first temperature control measure.

4. The chemical processing apparatus according to claim 3, where the energy given with the measure for giving energy includes at least one of photoenergy, electrical energy, sound energy, mechanical vibration energy, electromagnetic energy and radiation energy, except thermal energy to be given for temperature control.

5. The chemical processing apparatus according to claim 1, where one partial region under temperature control with the first temperature control measure is positioned upward the other partial region under temperature control with the second temperature control measure.

6. The chemical processing apparatus according to claim 1, where one partial region or the other partial region is in the vicinity of the inner wall of the container while the inner wall of the container or the outer wall of the container is temperature-controlled with the first or second temperature control measure.

7. The chemical processing apparatus according to claim 1, where the chemical processing apparatus including one or more reaction chambers with one or more separators inside the container, where one partial region or the other partial region is in the vicinity of the separators of the reaction chamber and the separators are temperature-controlled with the first or second temperature control measure.

8. The chemical processing apparatus according to claim 7, where the container is of a double-tube structure comprising the inner tube and the outer tube arranging the inner tube inside, while the separators are a part or the whole of the tube walls of the inner tube and the outer tube.

9. The chemical processing apparatus according to claim 7, where the container has a structure where plural parallel planes form a space and the separators are a part or the whole of the parallel planes.

10. The chemical processing apparatus according to claim 1, where the chemical processing apparatus contains a flow measure of solvent solutions, which works for first and second solvent solutions to flow from one partial region to the other partial region and/or for the first and second solvent solutions to flow from the other partial region to one partial region.

11. The chemical processing apparatus according to claim 1, where the substance to be involved in the reaction of the chemical process is a catalyst soluble in either one of the first solvent and the second solvent but hardly soluble in the remaining one of the first solvent and the second solvent and the reaction of the chemical process is a synthetic reaction of a compound, utilizing the catalyst.

12. The chemical processing apparatus according to claim 1, where the substance to be involved in the reaction of the chemical process is a carrier compound of a peptide soluble in either one of first and second solvents and hardly soluble in the remaining one of the first and second solvents and the reaction of the process is a peptide synthesis reaction for binding sequentially amino acids onto the carrier compound.

13. The chemical processing apparatus according to claim 4, where the energy to be given is photoenergy and the measure for giving photoenergy comprises a source generating light and an optically transmitting substance as a part or the whole of a container material, or an optically wave guide measure with a wave guide end in one partial region inside the container, so that the photoenergy from the source generating light is given through the optically transmitting substance or the optically wave guide measure to the one partial region.

14. The chemical processing apparatus according to claim 4, where the energy to be given is electrical energy and the measure for giving electrical energy includes an electrode for electrochemical reaction, as a cathode arranged in one partial region inside the container and an outer electric source in electric connection with the electrode.
